(19) United States
(12) Patent Application Publication
(10) Pub. No.: US 2004/0176152 A1
(43) Pub. Date: Sep. 9, 2004

(54) Digital image capture device combined with the function of a pocket game

(76) Inventor: Chang-Jung Hsieh, Hsin Chu Hsien (TW)

Correspondence Address: BROWDY AND NEIMARK, P.L.L.C., 624 NINTH STREET, NW, SUITE 300, WASHINGTON, DC, 20001-5303, US

(21) Appl. No.: 10/379,903

(22) Filed: Mar. 6, 2003

(51) Int. Cl. A63F 13/00

(52) U.S. Cl. 463/1

(57) ABSTRACT

A digital image capture device incorporated with the function of a pocket game is provided. The digital image capture device is either a digital camera or a digital video for capturing images. At least one game program is capable of being presented on the digital image capture device. The digital image capture device incorporated with the function of a pocket game comprises: a processing unit for executing the game program; a memory unit, connected to the processing unit, for storing the game program; a display unit, connected to the processing unit, for displaying dynamic images when executing the game program; and an operation unit, connected to the, processing unit, for controlling motions of the game program.

### BACKGROUND OF THE INVENTION

1. Field of the Invention

The present invention relates to a digital image capture device combined with the function of a pocket game. More particularly, the present invention relates to a digital camera or a digital video, which is incorporated with a pocket game.

2. Description of the Prior Art

Megapixel digital cameras and digital videos (both hereinafter referred to as digital image capture devices) are coming down in price, while the quality and number of features of these devices keeps going up. Some projections suggest that digital cameras will become as popular as film-based cameras in the near future. Most digital image capture devices come with an LCD (liquid crystal display), which is often used as a viewfinder. It also allows users to review images in memory, which when in use, is inserted into a memory slot provided on the digital image capture device. However, the conventional digital image capture devices can only implement mono function of image capturing, data memorizing, or playing, which in one aspect, is such as waste. So far, on the market, there is no digital image capture device that is incorporated with a pocket game, which also uses an LCD screen and memory cards.

Typically, a pocket game has its own structure that is different from the structure of a digital image capture device. In some cases, the pocket game is built in a mobile phone, PDA, or Palm. Further, users of the conventional pocket game can only play games that are embedded in read only memory of the pocket game. It is difficult for the user to play other games that are not embedded in the memory of the pocket game because there is no extension memory slot provided on the pocket game.

### SUMMARY OF THE INVENTION

Accordingly, the main objective of the invention is to provide a digital image capture device incorporated with a pocket game.

To achieve the above goals, a digital image capture device incorporated with the function of a pocket game is provided. The digital image capture device is either a digital camera or a digital video for capturing images. At least one game program is capable of being presented on the digital image capture device. The digital image capture device incorporated with the function of a pocket game comprises: a processing unit for executing the game program; a memory unit, connected to the processing unit, for storing the game program; a display unit, connected to the processing unit, for displaying dynamic images when executing the game program; and an operation unit, connected to the processing unit, for controlling motions of the game program.

According to one aspect of this invention, the digital image capture device incorporated with the function of a pocket game further includes a sound unit connected to the processing unit for playing music or sound of the game program. The sound unit comprises an audio processor, a microphone and a speaker.

According to one aspect of this invention, the digital image capture device incorporated with the function of a pocket game further includes a storage unit, connected to the processing unit, for storing a plurality of game programs, which can be executed through the operation unit.

According to one aspect of this invention, the digital image capture device incorporated with the function of a pocket game further includes an extending connection unit, connected to the processing unit, for connecting with an additional memory card or a game memory. The extending connection unit is connected to a computer through a connecting line, thereby downloading an extra game program. The extending connection unit is connected to an internal website through the computer, thereby downloading an extra game program.

Other objects, advantages and novel features of the invention will become more clearly and readily apparent from the following detailed description when taken in conjunction with the accompanying drawings.

### BRIEF DESCRIPTION OF THE DRAWINGS

FIG. 1 is a block diagram illustrating a digital image capture device according to the prior art.

FIG. 2 is a block diagram illustrating a pocket game according to the prior art.

FIG. 3 is a block diagram illustrating one preferred embodiment of this invention.

FIG. 4 is a block diagram according to another embodiment of this invention.

FIG. 5 is a block diagram according to still another embodiment of this invention.

FIG. 6 is a flowchart of implementing the initializing program according to the present invention.

FIG. 7 is a flowchart of executing the game program.

### DETAILED DESCRIPTION OF THE PREFERRED EMBODIMENTS

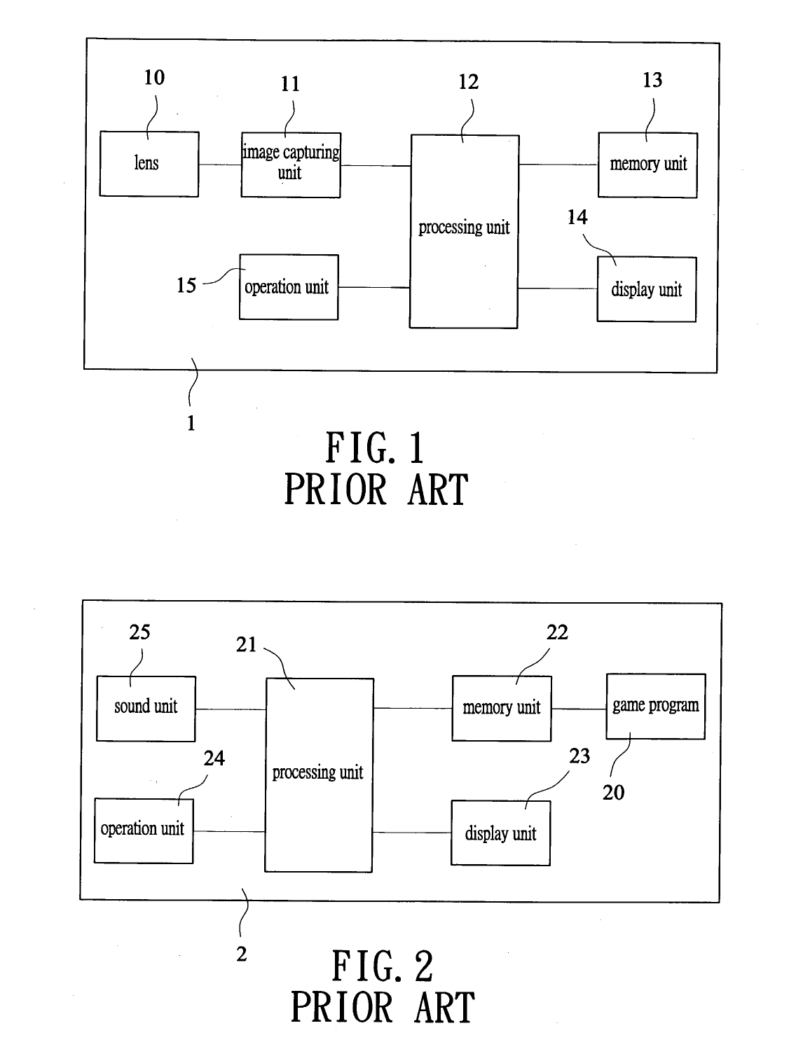

Please refer to FIG. 1 and FIG. 2, where FIG. 1 is a block diagram illustrating a digital image capture device according to the prior art, FIG. 2 is a block diagram illustrating a pocket game according to the prior art. The digital image capture device 1 as set forth in FIG. 1 may be a digital camera or a digital video (DV) for capturing images. As shown in FIG. 1, the digital image capture device 1 includes a lens 10, an image capturing unit 11 such as a CCD or CMOS device, a processing unit 12, a memory unit 13, a display unit 14, and a operation unit 15. As shown in FIG. 2, a typical pocket game 2 can play at least one game program. The typical pocket game 2 comprises a processing unit 2I, a memory unit 22, a display unit 23, an operation unit 24, and sound unit 25.

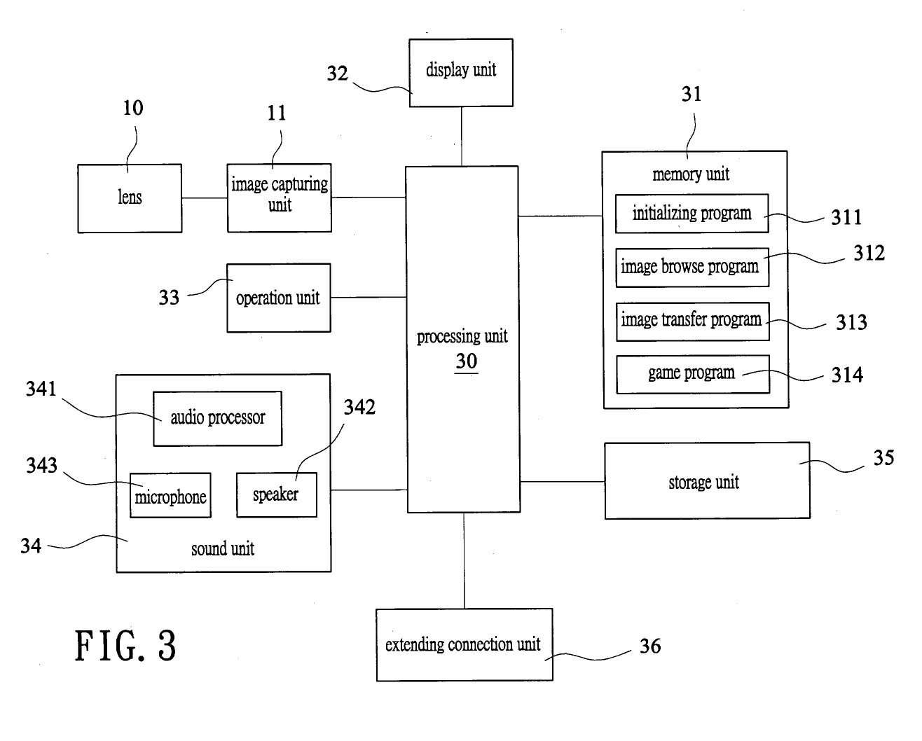

Please refer to FIG. 3. FIG. 3 is a block diagram illustrating one preferred embodiment of this invention. The present invention features the combination of a conventional pocket game 2 and a conventional digital image capture device 1. The present invention takes advantage of the common devices such as the processing unit, the memory unit, and the display unit and uses these common devices in the combination of a new device, which can be switched between a digital image capturing mode and a game mode. The present invention comprises a processing unit 30, a memory unit 31, a display unit 32, an operation unit 33, a sound unit 34, and a storage unit 35 for storing game programs.

The processing unit 30 can implement the capturing, saving, or transferring of image data, and the processing unit 30 can execute a game program 314 as well. The memory unit 31 is connected to the processing unit 30. The memory unit 31 is used to store the image data captured by the processing unit 30, or store the game program 314 executed by the processing unit 30. The programs saved in the memory unit 31 may further comprise an initializing program 311, an image browsing program 312, an image transferring program 313, and the game program 314.

The display unit 32 is connected to the processing unit 30. Preferably, the display unit 32 is an LCD for displaying the static or dynamic images. The operation unit 33 is connected to the processing unit 30. The operation unit 33 comprises function buttons and/or control buttons for controlling directions. The function buttons include a selection button for switching the image capturing mode or the game mode, an image capturing button, an image view button, an image amplify button, an image shrinking button, delete button, or an image transfer button. The controlling buttons is used to control the motion of the game program 314.

The sound unit 34 is connected to the processing unit 30. The sound unit 34 comprises an audio processor 341 and a speaker 342 for presenting the music or sound of the game program 314. The sound unit 34 further comprises a microphone 343 for recording sound which can be stored in the memory unit 31. The storage unit 35 is connected to the processing unit 30. A plurality of game programs are stored in the storage unit 35. A user can select a game program 314 he or he wants to play through the operation unit 33, and then loads the game program into the memory unit 31, such that the processing unit 30 can implement the program.

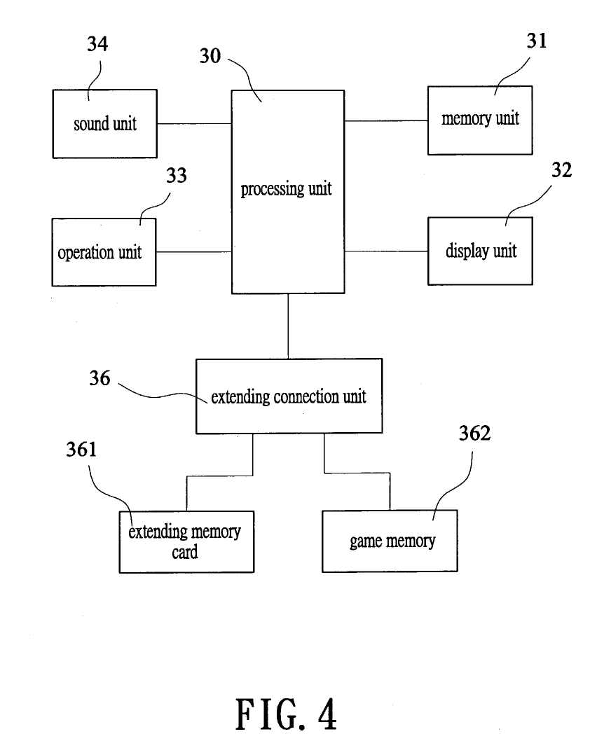

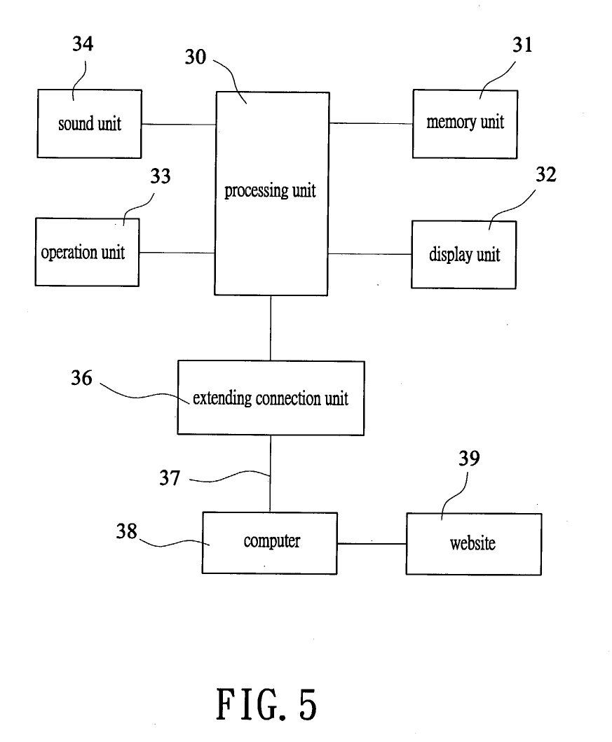

Please refer to FIG. 4, where FIG. 4 is a block diagram according to another embodiment of this invention, FIG. 5 is a block diagram according to still another embodiment of this invention. According to this invention, to extend the number of the game program 314, an extending connection unit 36 is provided, which is also connected to the processing unit 30. The extending connection unit 36 may be an extending memory slot for connecting an additional memory card 361 or game memory 362. The memory card 361 has at least one non-volatile memory. The game memory 362 stores at least one game program that is different from the game program 314 stored in the storage unit 35. The extending connection unit 36 may be a connection interface capable of being connected to a computer 38 through a connecting line 37 to download more game programs from the computer 38 or to connect the internet website 39 to download more game programs 314.

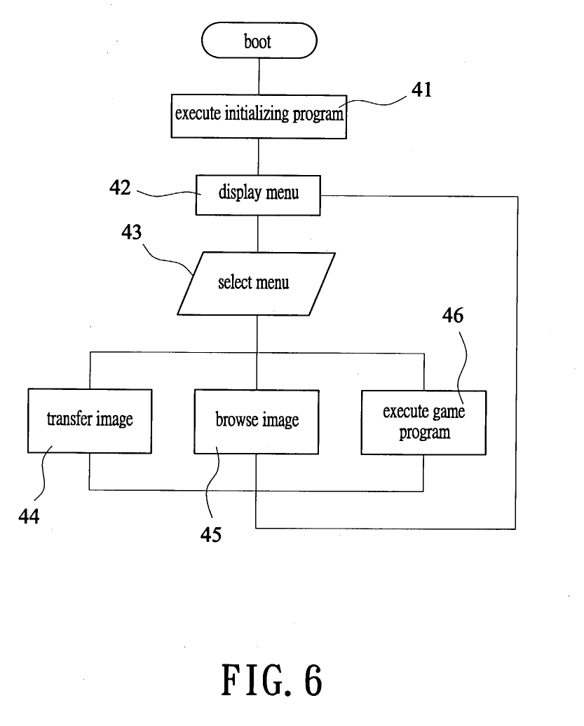

Please refer to FIG. 6. FIG. 6 is a flowchart of implementing the initializing program according to the present invention. As shown in FIG. 6, after booting the digital image capture device incorporated with the pocket game, the initializing program 311, (41) is first executed. A menu (42) showing items to be executed is displayed on the display unit 32. These items include image transfer (44), image browse (45), and game program 314 execute (46). A user can select the above-mentioned items through the operation unit 33 and then execute corresponding programs.

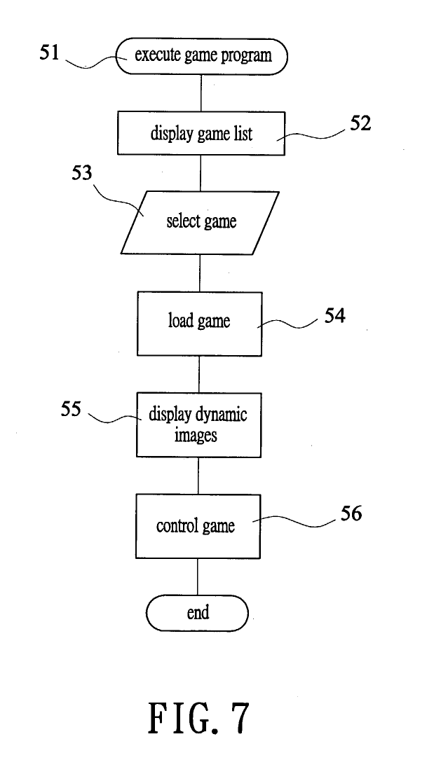

Please refer to FIG. 7. FIG. 7 is a flowchart of executing the game program. After the user select an item of game program 314 execute (51), the processing unit 30 will display a list of game programs stored in the storage unit 35 on the display unit 32 (52). The user then selects the game to be played in the list through the operation unit 33 (53). The selected game program 314 is then loaded into the memory unit 31 by the processing unit 30 (54). The dynamic images of the game program 314 are showed on the display unit 32 (55). The user can control the motions of the game program 314 through the direction control buttons on the operation unit 33 (56).

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A digital image capture device incorporated with the function of a pocket game, the digital image capture device being either a digital camera or a digital video for capturing images, at least one game program being capable of being presented on the digital image capture device, the digital image capture device incorporated with the function of, a pocket game comprising:
a processing unit for executing the game program;
a memory unit, connected to the processing unit, for storing the game program;
a display unit, connected to the processing unit, for displaying dynamic images when executing the game program; and
an operation unit, connected to the processing unit, for controlling motions of the game program.

2. The digital image capture device incorporated with the function of a pocket game as claimed in claim 1 further comprising a sound unit connected to the processing unit for playing music or sound of the game program.

3. The digital image capture device incorporated with the function of a pocket game as claimed in claim 2 wherein the sound unit comprises an audio processor and a speaker.

4. The digital image capture device incorporated with the function of a pocket game as claimed in claim 3 wherein the sound unit further comprises a microphone for recording sound or voice that is stored in the memory unit.

5. The digital image capture device incorporated with the function of a pocket game as claimed in claim 1 further comprising a storage unit, connected to the processing unit, for storing a plurality of game programs, which can be executed through the operation unit.

6. The digital image capture device incorporated with the function of a pocket game as claimed in claim 1 further comprising an extending connection unit, connected to the processing unit, for connecting with an additional memory card or a game memory.

7. The digital image capture device incorporated with the function of a pocket game as claimed in claim 6 wherein the extending connection unit is connected to a computer through a connecting line, thereby downloading an extra game program.

8. The digital image-capture device incorporated with the function of a pocket game as claimed in claim 7 wherein the extending connection unit is connected to an internal website through the computer, thereby downloading an extra game program.

9. The digital image capture device incorporated with the function of a pocket game as claimed in claim 6 wherein the extending memory card comprises at least one non-volatile memory.

10. The digital image capture device incorporated with the function of a pocket game as claimed in claim 6 wherein the game memory comprises at least one game program.

11. The digital image capture device incorporated with the function of a pocket game as claimed in claim 1 wherein the processing unit can implement image capturing, saving, or transferring.

12. The digital image capture device incorporated with the function of a pocket game as claimed in claim 1 wherein the images captured by the processing unit is stored in the memory unit.

13. The digital image capture device incorporated with the function of a pocket game as claimed in claim 1 wherein the programs stored in the memory unit comprise an initializing program, an image browsing program, an image transferring program, and game programs.

14. The digital image capture device incorporated with the function of a pocket game as claimed in claim 1 wherein the display unit is a liquid crystal display (LCD).

15. The digital image capture device incorporated with the function of a pocket game as claimed in claim 1 wherein the operation unit comprises function operating buttons or direction control buttons.

16. The digital image capture device incorporated with the function of a pocket game as claimed in claim 15 wherein the function operating buttons comprise image select, capture mode, or game mode.

17. The digital image capture device incorporated with the function of a pocket game as claimed in claim 15 wherein the operation unit includes an image capturing button, an image view button, an image amplify button, an image shrinking button, delete button, and an image transfer button.
